(19) United States
(12) Patent Application Publication
(10) Pub. No.: US 2006/0142025 A1
(43) Pub. Date: Jun. 29, 2006

(54) Vehicle stereo system

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/072,538

(22) Filed: Mar. 7, 2005

(30) Foreign Application Priority Data
Dec. 27, 2004 (TW) 093140780

(51) Int. Cl. H04Q 7/20

(52) U.S. Cl. 455/456.1

(57) ABSTRACT

A vehicle stereo system installed in a motor vehicle is disclosed to include a global positioning module that calculates the present location data of the motor vehicle, a memory device that has stored therein radio network records, each radio network record containing a plurality of geographic zones, and a plurality of receiving frequencies of a same radio network for use to receive radio programs of the same radio network in the respective geographic zones correspondingly, a vehicle stereo that has a tuner and a speaker, and a microprocessor that fetches the present location data of the motor vehicle, searches the memory device to find out a receiving frequency of the same radio network corresponding to the geographic zone, and controls the tuner to tune the vehicle stereo to the searched receiving frequency for output radio programs of the same radio network through the speaker.

### BACKGROUND OF THE INVENTION

1. Field of the Invention

The present invention relates to a vehicle stereo system and more particularly, to such a vehicle stereo system, which automatically switches the receiving frequency when entered a new geographic zone during driving.

2. Description of Related Art

A motor vehicle generally has installed therein an audio apparatus, for example, radio, so that the driver can listen to a music, comic dialogue, or other program from the radio when driving the car.

When listening to the radio, the driver can select channels to receive different programs from different radio stations subject one's preference. Regular radio stations are identified by frequency, for example, the frequency of one radio station is 100, the frequency of another radio station is 110, the frequency of still another radio station is 120, etc. The vehicle driver can tune the vehicle stereo (radio receiver) to receive different programs from different radio stations.

Further, different radio stations in different geographic zones may form a radio network to broadcast same joint programs. For example, the receiving frequency of a radio network is 130 in a first geographic zone and 140 in a second geographic zone. When a vehicle driver drives the motor vehicle from the first geographic zone to the second geographic zone, the vehicle driver must tune the receiving frequency of the vehicle stereo to 140 so as to receive the same joint program. It is inconvenient and dangerous to tune the vehicle stereo when driving the motor vehicle.

### SUMMARY OF THE INVENTION

The present invention provides a vehicle stereo system installed in a motor vehicle. The vehicle stereo system is comprised of a global positioning module, a memory device, a vehicle stereo, and a microprocessor. The global positioning module is adapted to calculate the present location data of the motor vehicle. The memory device has stored therein at least one radio network record. Each radio network record contains a plurality of geographic zones, and a plurality of receiving frequencies of a same radio network for use to receive radio programs of the same radio network in the respective geographic zones correspondingly. The vehicle stereo comprises a tuner and at least one speaker. The microprocessor is adapted to fetch the present location data of the motor vehicle calculated by the global positioning module, to search the memory device to find out a receiving frequency of the same radio network corresponding to the geographic zone where the present location data of the motor vehicle located in, and to control the tuner to tune the vehicle stereo to the searched receiving frequency for output radio programs of the same radio network through the at least one speaker. When the driver drives the motor vehicle to a different geographic zone, the vehicle stereo system automatically switches the receiving frequency so that the driver can enjoy the same joint program in different geographic zones without tuning the frequency manually.

The global positioning module can be a GPS (Global Positioning System) module. Alternatively, a three-points positioning method may be employed to calculate the present location of the motor vehicle, for example, a cellular phone can be searched its location by the locations of three base stations.

Further, the geographic zones stored in the memory device correspond to the receiving frequencies of the same radio network in a one-to-one manner. The vehicle stereo can be a FM receiver or AM receiver. The vehicle stereo system further comprises a display device adapted to display the searched receiving frequency of the same radio network from which the vehicle stereo is receiving, or to display the name of the radio network.

### BRIEF DESCRIPTION OF THE DRAWINGS

FIG. 1 is a schematic drawing showing a status of use of the present invention.

FIG. 2 is a system block diagram of a vehicle stereo system according to the present invention.

FIG. 3 is a schematic drawing illustrating the storage content of the memory device of the vehicle stereo system.

### DETAILED DESCRIPTION OF THE PREFERRED EMBODIMENT

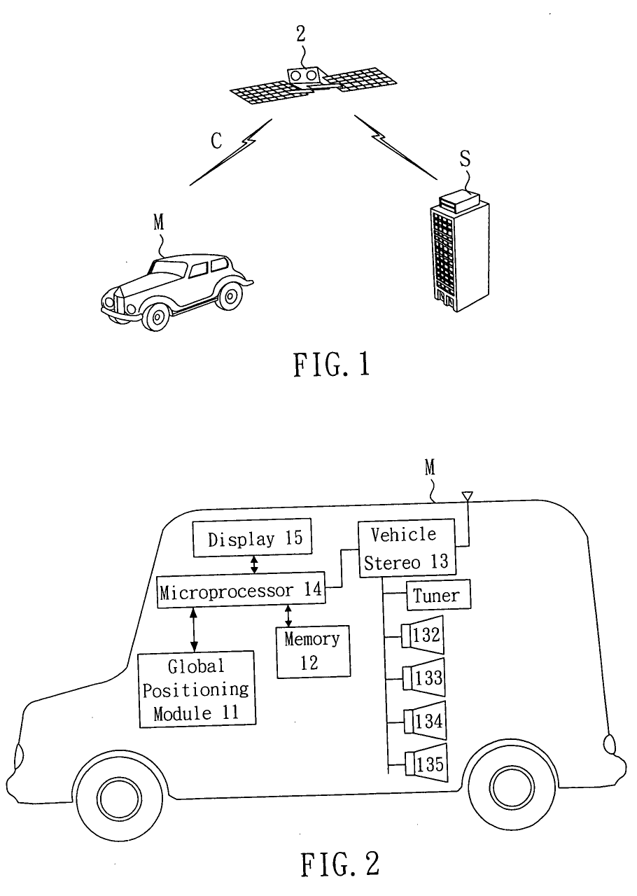

FIG. 1 is a schematic drawing showing a status of use of the present invention where there are shown a motor vehicle M, a satellite 2, and a a radio network S.

Referring to FIG. 2 and FIG. 1 again, the motor vehicle M has installed therein a vehicle stereo system, which comprises a global positioning module 11, a memory device 12, a vehicle stereo 13, a microprocessor 14, and a display 15.

Referring to FIG. 2 and FIG. 3 and FIG. 1 again, the global positioning module 11 calculates the present location data C of the motor vehicle M. According to the present preferred embodiment, the global positioning module 11 is a GPS (Global Positioning System) module that obtains the data of the present location of the motor vehicle M from the satellite 2.

The memory device 12 has stored therein the radio network records R of three radio stations A, B, C that broadcast joint programs. Each radio network record R contains four geographic zones A1, A2, A3, A4 and four receiving frequencies F1, F2, F3, F4. The four receiving frequencies F1, F2, F3, F4 of each radio network record R are the respective radio receiving frequencies of the same radio network S of the radio network in the four geographic zones A1, A2, A3, A4. For example, the receiving frequency of the radio station A in Ohio State is 98.3, and its receiving frequency in Oregon State is changed to 101.8.

According to the present preferred embodiment, each radio network record R contains four geographic zones A1, A2, A3, A4 and four receiving frequencies F1, F2, F3, F4. Alternatively, each radio network record R can be set to contain five geographic zones and five receiving frequencies corresponding to the five geographic zones, or to contain six or seven geographic zones and six or seven receiving frequencies corresponding to the six or seven geographic zones.

Further, the geographic zones A1, A2, A3, A4 stored in the memory device 12 correspond to the receiving frequencies F1, F2, F3, F4 of one same radio network S in a one-to-one manner, i.e., there is only one receiving frequency F in one particular geographic zone A1. When entered another geographic zone A2, there is another receiving frequency F2. It is practical to have one receiving frequency correspond to multiple geographic zones, i.e., one same receiving frequency in two or three geographic zones.

Further, the aforesaid vehicle stereo 13 comprises a tuner 131 and four speakers 132, 133, 134, 135. According to the present preferred embodiment, the vehicle stereo 13 is a FM receiver, and the so-called four receiving frequencies correspond to a respective FM frequency. Of course, AM frequency may be employed.

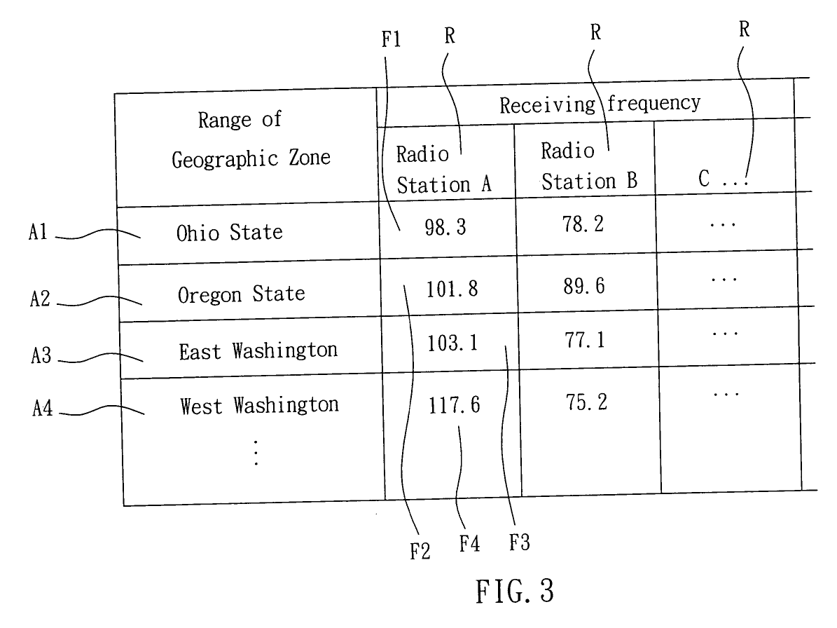

When the motor vehicle M entered a particular geographic zone A1, for example, Ohio State as shown in FIG. 3, the driver can receive joint programs from radio station A. When the driver keeps driving the motor vehicle M, the global positioning module 11 keeps calculating the present location data C of the motor vehicle M. When the motor vehicle M entered another geographic zone A2, for example, Oregon State in FIG. 3, the microprocessor 14 fetches the present location data C of the motor vehicle M calculated by the global positioning module 11, and then searches the receiving frequency F2 of the same radio network S corresponding to the geographic zone A2 of the present location data C, i.e., the receiving frequency F2 of the radio station A in Oregon State, and then controls the tuner 131 to search the desired receiving frequency F2 for output through the speakers 132, 133, 134, 135. At the same time, the display 15 displays the name of the radio network S and the receiving frequency F1.

If the driver drives the motor vehicle M into another geographic zone A3, for example, East Washington as shown in FIG. 3, the microprocessor 14 fetches the present location data C of the motor vehicle M calculated by the global positioning module 11, and then searches the receiving frequency F3 of the same radio network S corresponding to the geographic zone A3 of the present location data C, i.e., the receiving frequency F3 of the radio station A in East Washington, and then controls the tuner 131 to search the desired receiving frequency F3 for output through the speakers 132, 133, 134, 135, and at the same time, the display 15 displays the name of the radio network S and the receiving frequency F3.

By means of the aforesaid arrangement, the vehicle stereo 13 automatically switches to the respective receiving frequency F1, F2, F3, F4 when the driver drives the motor vehicle M into a different geographic zone A1, A2, A3, A4, enabling the driver to enjoy the same joint program in different geographic zones A1, A2, A3, A4 without switching the receiving frequency F1, F2, F3, F4 manually.

Although the present invention has been explained in relation to its preferred embodiment, it is to be understood that many other possible modifications and variations can be made without departing from the spirit and scope of the invention as hereinafter claimed.

What is claimed is:

1. A vehicle stereo system installed in a motor vehicle, comprising:
a global positioning module adapted to calculate the present location data of said motor vehicle;
a memory device, said memory device having stored therein at least one radio network record, each said radio network record containing a plurality of geographic zones, and a plurality of receiving frequencies of a same radio network for use to receive radio programs of said same radio network in said respective geographic zones correspondingly;
a vehicle stereo, said vehicle stereo comprising a tuner and at least one speaker; and
a microprocessor adapted to fetch the present location data of said motor vehicle calculated by said global positioning module, to search said memory device to find out a receiving frequency of said same radio network corresponding to the geographic zone where the present location data of said motor vehicle located in, and to control said tuner to tune said vehicle stereo to the searched receiving frequency for output radio programs of said same radio network through said at least one speaker.

2. The vehicle stereo system as claimed in claim 1, wherein said global positioning module is a GPS (Global Positioning System) module.

3. The vehicle stereo system as claimed in claim 1, wherein the geographic zones stored in said memory device correspond to the receiving frequencies of said same radio network in a one-to-one manner.

4. The vehicle stereo system as claimed in claim 1, wherein said vehicle stereo comprises a FM receiver, said receiving frequencies are FM frequencies.

5. The vehicle stereo system as claimed in claim 1, further comprising a display device adapted to display the searched receiving frequency of said same radio network from which said vehicle stereo is receiving.
